(19) United States
(12) Patent Application Publication
(10) Pub. No.: US 2011/0115931 A1
(43) Pub. Date: May 19, 2011

(54) IMAGE MANAGEMENT SYSTEM AND METHOD OF CONTROLLING AN IMAGE CAPTURING DEVICE USING A MOBILE COMMUNICATION DEVICE

(76) Inventors: Joseph M. Kulinets, North Andover, MA (US); Peter R. Nuytkens, Melrose, MA (US)

(21) Appl. No.: 12/620,493

(22) Filed: Nov. 17, 2009

(51) Int. Cl. H04N 5/232

(52) U.S. Cl. 348/211.2; 348/E05.042

(57) ABSTRACT

An image management system and method of controlling an camera using a mobile computing device is described. The system includes a mobile computing device and an image taking system connected to a server. The image taking system includes a camera oriented towards distinguishing mark; and a control unit in communication with the mobile computing device such that the control unit transfers the control functions of the camera to the mobile computing device such that the mobile computing devices operates the camera to capture an image. The method includes establishing, by a mobile communication unit, an image capturing session with an image capturing system, the image capturing system having a control unit; transmitting, by the control unit, to the mobile computing device control functions for controlling operation of a camera; capturing, by the camera, an image in response to operation by the mobile communication unit; and creating, by the image capturing system, a media file.

### BACKGROUND

1. Technical Field

The present disclosure relates generally to image management systems. In particular, the present disclosure relates to an image management system and method to control the image taking device using a mobile computing device.

2. Description of Related Art

Digital photography uses digital technology to take images of subjects that can be displayed, printed, stored, manipulated, transmitted, and archived using digital and computer techniques. The public has embraced this technology thanks in part to the many technological advances that has occurred and continues to occur.

However, digital photography, with all its advances, continues to face obstacles. For example, it is often difficult or practically impossible to take an image of the subject in certain settings, such as museums, which often prohibit the taken of photos and videos; water parks, when the subject is sliding in a water slide; or in ski resorts, where a skier is seated in a lift chair or suspended in the air during a jump. Other examples include, difficult to reach spots or spots from unusual perspectives, etc.

Another common problem arises when, for example, a person is unaccompanied or when a group of persons want to capture a photograph the group. In these situations, it is necessary to use a tripod or asking a bystanders for help since current devices are designed to be manually operated with a user behind the camera device.

Although many camera manufacturers include a remote unit to operate the camera device remotely, setting up the camera device for using these accessories is cumbersome and often requires external accessories. Various solutions have been proposed, for example, in sightseeing spots such as a museum, an amusement park and a theme park, services are provided for selling a print of an image of a customer photographed during an attraction. In particular, many locations have installed photography systems for taking pictures that customer would not be otherwise permitted to or able to take. However, these systems permit no input from the customer as to the characteristics of the image. That is, the customer has no control over the capturing of the image. In addition, these systems require a registration by a customer. The registration process requires, inter alia, personal identifying information from a customer. This identifying information is stored and later associated with an image. In other examples, the system automatically, and often times randomly, captures images of the customer and later associates the image data to the identifying information. Sometimes, the image data obtained throughout the session is stored together with the identifying information of the customer.

The present disclosure is directed to image management system and method of controlling an image capturing device using a mobile computing device and that requires no registration by the customer.

### SUMMARY

The present disclosure is directed to an image management system and method to control the capturing of an image via a mobile computing device. In one embodiment, a media management system is described. The system includes a mobile computing device and an image taking system connected to a server. The image taking system includes an image capturing device oriented towards distinguishing mark, the image capturing device having a plurality of control functions, and a control unit in communication with the mobile computing device such that the control unit transfers the control functions to the mobile computing device for controlling operation of the image capturing device, where the mobile computing device operates the image capturing device to capture an image. The control unit then transmits the image to the server. The server uses an identifier corresponding to the mobile computing device to index and store the image. It is noted that the distinguishing marks are at a predetermined location for establishing a preferred position of a subject.

In one particular embodiment, the mobile computing device receives a password generated by the control unit. The password is associated with an identifier corresponding to the mobile computing device prior to controlling operation of the image capturing device. Thus, the captured image is associated with an identifier corresponding to the mobile computing device. The identifier corresponding to the mobile computing device is either a mobile communication number (e.g. a cell phone number) or a serial number.

In accordance with the present disclosure, the control unit generates a media file and transfers the media file to the server. The media file includes the captured image and the identifier corresponding to the mobile computing device. The server then indexes the media file according to the identifier corresponding to the mobile computing device. A media output terminal can later retrieve the media file in response to receiving an identifier corresponding to the mobile computing device. In another embodiment, the media output terminal receives the identifier corresponding to the mobile computing device, and retrieves the captured image.

In one particular embodiment, the control unit transmits an image from the image-capturing device to a display of the mobile computing device.

The control functions of the image-capturing device include zoom, pan, tilt, image capture, time-elapse image capture, and a combination thereof. In one embodiment, the image-capturing device is one of a digital camera and a video camera and the captured image is one of a still image or a video. The mobile computing device may be a cellular-enabled wireless device.

In one particular embodiment, the mobile computing device creates an audio file, and the audio file is associated with the captured image. Thus, the media file includes the captured image, the audio file and an identifier corresponding to the mobile computing device.

In another embodiment, the media management system includes a mobile computing device and an image capturing system in communication with the mobile computing device. The image capturing system includes an image capturing device oriented towards a visually distinguishing mark and a communication control unit that establishes an image capturing session in response to an initiation by the mobile computing device. The communication control unit detecting an identifier associated with the mobile computing device, where the communication control unit transmits to the mobile computing device a menu of control functions to control operation of the image capturing device to capture captured image and where the image capturing system creates a media file by associating the identifier of the mobile computing device with the least one image, and further where the image capturing system transmits the media file to a server. The communication control unit receives instructions from the mobile computing device to control operation of the image capturing device. In this embodiment, the mobile computing device is at least one of a PDA, a cell phone, a laptop, an i-phone, and a cellular-enabled wireless device. The control function includes zoom, pan, tilt, media capture, and time-elapse media capture.

The image management system further includes an output terminal that receives, from a customer, an authentication token associated with the mobile computing device, associates the authentication token with the identifier, retrieves media file corresponding to the identifier and transfers media from the media file to at least one of a printer, a storage device and a computing device.

A method of operating an image-capturing device using a mobile computing device is also described. The method includes establishing, by a mobile computing device, an image capturing session with an image-capturing system, the image-capturing system having a control unit; transmitting, by the control unit, to the mobile computing device control functions for controlling operation of an image-capturing device; capturing, by the image-capturing device, captured image in response to operation by the mobile computing device; and creating, by the image-capturing system, a media file, the media file having the captured image and an identifier associated with the mobile computing device. The method further includes streaming, by the control unit, the captured image to the mobile computing device, prior to capturing the captured image. Moreover, the method further includes, transmitting, by the image-capturing system, the media file to a server, and retrieving, by an output terminal, the media file from the server, in response to an initiation session.

In one embodiment, the initiation session includes receiving, by the output terminal, the identifier associated with the mobile computing device.

In one particular embodiment, the method further includes receiving, by the control unit, an audio file created by the mobile computing device, where the control unit associates the audio file with the at least one captured image. The mobile computing device receives a password generated by the control unit. The password can be temporary. The password is associated with the identifier corresponding to the mobile computing device prior to controlling operation of the image-capturing device. Alternatively, the control unit or the mobile computing device establishes an authentication token for retrieving the media file.

Other aspects, features and advantages of the presently disclosed image management system and methods of controlling image capturing using a mobile computing device will become apparent from the following detailed description taken in conjunction with the accompanying drawing, which illustrate, by way of example, the presently disclosed system and method.

### BRIEF DESCRIPTION OF THE DRAWINGS

The features of the presently disclosed image management system and method will be described in detailed herein below with references to the figures, wherein:

FIG. 1 illustrates an exemplary top-level block diagram of an image management system, in accordance with one embodiment of the present disclosure;

FIG. 2 illustrates a block diagram of an image taking system, in accordance with one embodiment of the present disclosure;

FIG. 3 illustrates a block diagram of the image taking system, in accordance with a second embodiment of the present disclosure;

FIG. 4 illustrates a top level block diagram of a photo terminal, in accordance with one embodiment of the present disclosure;

FIG. 5 is an exemplary flow diagram of a method to control the process of taking an image during the image taking session according to the present invention; and

FIG. 6 is an exemplary flow diagram of a second embodiment of a method of controlling the process of taking an image during the image taking session, according to the present invention.

### DETAILED DESCRIPTION

Referring now to the drawing figures, wherein like references numerals identify identical or corresponding elements, an embodiment of the presently disclosed media management system and method will be described in detail.

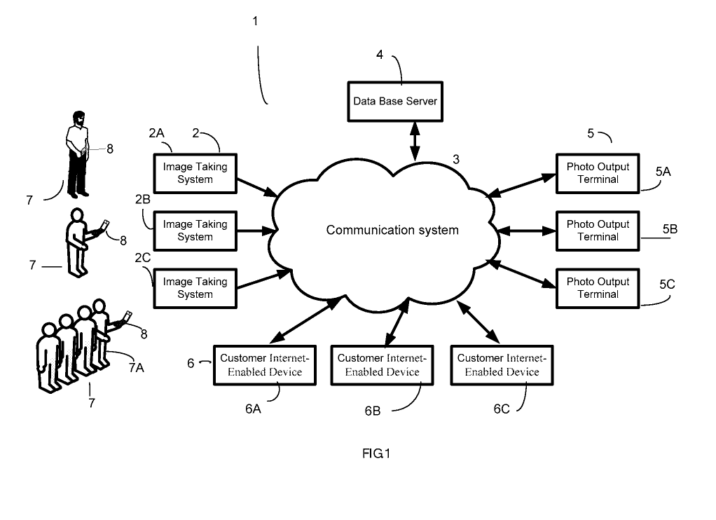

FIGS. 1-6 illustrate a media management system and method for controlling the taking of the image. In particular, a plurality of image taking systems are installed at strategically predetermined locations. Each image taking system is in communication with a image-capturing device.

In one embodiment, the image management system includes a plurality of image taking systems. Each image taking system includes an image-capturing device, such as a digital camera or video camera. The image-capturing device is strategically placed at a predetermined location and is aimed at visually distinguishable marks. The visually distinguishable marks establish the preferred location of the subjects and are positioned at or around the space of a preferred location. The visually distinguishable marks can include any of a plurality of images or marks, such as, for example, corporate logos, color spots, elongated ellipses, circles, rectangles, lines, etc.

In a first embodiment, the image-taking device may, for example, zoom in and out of the visually distinguishing marks and capture an image (e.g. take pictures) in response to the command of a control unit connected thereto. In the following description, the image-capturing device may be interchangeably referred to as a “camera”, “digital camera” and “image-capturing device”. However, it should be understood that the image-capturing device, as envisioned by the present disclosure, is any device that records images, either as a still photograph or as moving images known as videos or movies.

Each one of the image-taking devices includes a control unit for controlling operation of the image-taking device. The control unit is connected to a cellular modem, where the cellular modem facilitates the transfer of the control functions of the image-taking device to a communication device, in manner described in detail herein below. The cellular modem includes a “caller ID” function for identifying at least one identifier information (e.g. cell phone number) associated with a mobile computing device. A mobile computing device, as the term is used through the present disclosure, includes mobile communication devices, and vice versa.

The control unit includes a display unit for displaying information to a customer during an image-taking session. As such, the display unit is visible to the customer when the customer is positioned at the visually distinguishable marks.

In accordance with the present disclosure, a customer eager to be serviced by the image management system would have a mobile computing device, such as, for example, cellular phone or a cellular-enabled wireless communication device, such as, for example, a notebook or PDAs. Thus, in operation, when a customer or a group of customers approach the visually distinguished marks, one of the customers takes the leading role as a “manager” composing the group and later controlling the zoom, tilt and angular rotation of the image capturing device, and the moment of taking the photo. The customer will dial a cellular number designated to the cellular modem of this particular image taking system. In one embodiment, the cellular phone number is displayed on the display unit connected to the camera control means. In another embodiment, the cellular number is written on a special sign or it is displayed proximate to the visually distinguished marks. Using the mobile computing device, the customer dials the designated cellular number, where identifier information corresponding to the mobile computing device is identified using the “caller ID” function of the cellular modem. The identifier information is stored in the camera control means and is temporally associated with the established image taking session. The camera control unit then generates and the display unit displays a numeric or alphanumeric random access code. The customer then uses the random access code to establish a session with the image management system. In one embodiment, if the dialed access code is invalid, the customer is asked to redial the access code. After a predetermined amount of unsuccessful attempts, the phone dialog is abrupt and the customer must again dial the cellular number so that the control unit can generate another access code. In any of these embodiments, the access code can be temporary.

As the session is initialized, the customer is urged to set up an alphanumeric password, this password is stored and associated with the mobile computing device for later accessing the images taken by the image-capturing device. After the customer establishes a password, the camera control unit begins the constant transmission (i.e. streaming) of the image as seen by the camera a display unit of the mobile computing device. Thus, the customer can control the image-capturing device by simply looking at the display of the mobile computing device.

When the image taking session is established, the control unit transfers the control functions of the image-capturing device to the mobile computing device such that the customer acquires the ability to control the functions of the image-capturing device via the mobile computing device. With the press of any designated button on the mobile computing device, the correspondent command is transmitted to the camera control unit, forcing the image-capturing device to perform the required action. The functions include, for example, zoom and image taking functions. In one embodiment, the customer is provided with a table correlating particular buttons of his communication device to particular camera control functions. The table is sent through a cellular phone network and can be displayed at the display unit of the mobile computing device. In one embodiment, the correlation can be assigned as follows:

1 —Zoom out;

### 3 —Zoom in;

### 0 —Shoot;

*—Shoot after 3 seconds of delay, etc.

As well known in the art, upon pressing the “shoot” button, the picture is taken. Upon pressing of any button assigned to the “shoot after delay” function, the picture will be taken after the specified delay. The function “shoot after delay” function is very useful to give to the customer some time to, for example, remove the mobile computing device from the field of vision of the camera.

After the image is taken, the control unit generates a media file. The media file includes the image merged with the identifier information corresponding to the mobile computing device. The media file is then transferred, by the camera control unit, to the remote server via a cellular connection, such as, for example 3G or 4G connection. The server then creates an index according to the mobile computing device. If, for example, the customer uses the same mobile computing device in different image taking systems positioned at different locations, the images taken by all of these image-taking systems will be stored in a database on the same server and associated with the same identifier information of the mobile computing device. The term “media”, as this term is used throughout the present disclosure is defined as “photography or data related to video and audio information” or the means of distribution thereof.

In another embodiment, the mobile computing device may create and transmit an audio message through the cellular phone connection to the camera control unit, where it will be stored as an audio file. The audio file can then be appended to the media file.

The customer can retrieve the media file from any Internet-enabled device, such as computer, smart phone, etc. The order can be placed for the purchase of photo prints, storage media (such as CD or DVD), or transfer the media files to an internet-enabled device.

To place an order the customer goes on the Internet to the image management system website and logs in using as a user name the identifier information of the mobile computing device used during taking the images. During the log in procedure the customer is asked to enter the alphanumeric password, upon entering which the customer receives the possibility to proceed with the order.

In response to the customer request to retrieve the media file, the server searches for all images and/or media files associated with the identifier information provided. In one embodiment, the server creates a low-resolution image file for each image stored and transfers it to the customer for review.

Using the image ordering software system of the server the customer places the order and pays for it using the credit card or any other remote payment system. For each file ordered as a print the customer can perform some editing of the image, creating the final photo to be printed. Any additional information related to the place where the photo picture was taken can be added to the final prints, or incorporated into the image files.

In another embodiment, the ordering of the media files can be made, for example, at the exits of museums, parks, etc, where the payment and fulfillment the order can be performed by the terminal in real time.

In one particular embodiment, the camera is placed on a digitally controlled movable platform, which is able to change the tilt and rotation angle (pan) of the digital camera under the control of the camera control unit based on the instructions sent from the mobile computing device. Thus, the customer controls the movement of the movable platform. For example, the table correlating particular buttons on the mobile computing device to the particular camera control functions, is augmented with such assignments as, for example:

4—Pan left;
6 —Pan right;

### 2 —Tilt up;

5 —Tilt down.

With initial reference to FIG. 1, an embodiment of an image management system and method of controlling operation of the image-capturing device using a mobile computing device, in accordance with the present disclosure, is illustrated and is designated generally as image management system 1. Image management system 1 includes a plurality of image taking systems 2A, 2B and 2C connected to a communication system 3 (e.g. the internet) via cellular communication means (not shown) using, for example, communication protocols such as 3G, 4G, etc. Communication system 3 facilitates the transfer of data between image taking systems 2, server 4, photo output terminal 5A, 5B and 5C and customer internet-enabled device 6A, 6B and 6C.

Media taking systems 2A, 2B and 2C may be installed at strategically selected spots across at least one place of interest, such as a tourist attraction (e.g. amusement, theme, water or nature park, botanical garden, museum, architecture ensemble, monument, or other tourist attractions, outing site, function hall or guided tour bus). Thus, one image management system 1 can manage the images taken in different time and in different places across the country or even across the world.

Image management system 1 further includes a plurality of media output terminals 5A, 5B, 5C, which can be placed, for example, at the places of interest, for example, at the exits of museums, parks, etc., and are used to place the order for prints or files on particular storage media, where the payment and fulfillment of the order can be performed by the terminals 5A, 5B and 5C in real time.

In accordance with the present disclosure, a customer 7 or a plurality of customers 7A, 7B and 7C can control operation of the image-taking system 2A, 2B and 2C via a mobile computing device 8. Mobile computing device 8 can be any one of a cellular-enabled wireless device such as a cell phone. Mobile computing device 8 can be any one of a PDA, a laptop, and an i-phone.

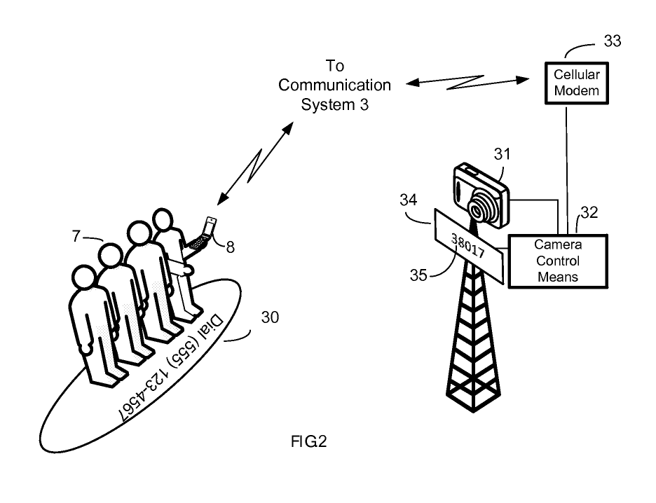

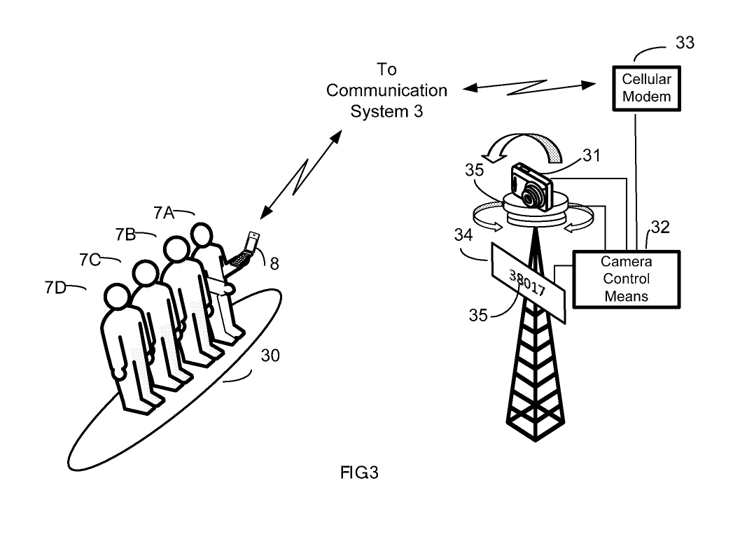

With reference to FIGS. 2 and 3, the image-taking system 2 includes at least one visually distinguished marks 30 proximal to a preferred location. An image-capturing device such as a digital camera 31 is strategically placed and mounted to a fixed position. Camera 31 is oriented (i.e. aimed at) towards the visually distinguished marks 30. In one particular embodiment, camera 31 is mounted on a digitally controlled rotating platform 35 (FIG. 3). The image-taking system further includes camera control means 32 having an embedded microprocessor system for controlling operation of the camera 31. In addition, control means 32 is connected to rotating platform 35 for changing the tilt and rotation angle (pan) of camera 31.

Control means 32 runs by the control of an embedded software (not shown) which, among other functions, controls various operations of camera 31, such as, for example, the zoom and shoot actions, etc., as well as provides the possibility of reading the file representing the image captured by of camera 31. In addition, control means 32 is connected to a cellular modem 33, which facilitates communication with mobile computing device 8 via communication system 3.

A display unit 34 is connected to control means 32 to display to a customer 7 instructions to initiate an image-taking session, in accordance with the present disclosure. Display unit 34 is positioned at a vicinity of the distinguished marks 30 such that the customer 7 can easily see unit 34 when the customer 7 is proximate to the visually distinguished marks 30.

With continued reference to FIGS. 2 and 3, the method of taking the images with the image taking system 2 according to the current disclosure will be described in detail.

When a customer 7 or group of customers 7A, 7B, 7C, and 7D want to capture at least one image, they position themselves in or near the visually distinguished marks 30. One customer 7 then takes the lead by controlling the operation of camera 35, in accordance with the present disclosure.

A telephone number associated with the cellular modem 33 is provided to the customer, by the display unit 35 or by a posting near camera 31 or near the distinguished marks 30 (as shown, for example in FIG. 2). Using a communication device 8, the customer 7 dials the designated telephone number and, upon successful connection, an identifier corresponding to the device 8, such as a cell phone number, is detected by “caller ID” function of the cellular modem 33. This identifier is stored in controlled means 32 and temporally associated with the current image taking session.

In some embodiments, the customer's device 8 includes an application that initiates a connection to the cellular modem 33. The customer can install the application on the device 8 from a webpage associated with the image management system 1. After installation, the application can appear on the device's display 8 as an icon, by way of example. When the customer 7 executes the application by selecting the icon via selecting an area of the touchscreen, the application can initiate the connection.

Control means 32 then generates a numeric or alphanumeric random access code 35, which is displayed in display unit 34. Customer 7 is then instructed to enter this access code into communication device 8 for establishing the image-taking session. If customer 7 dials an incorrect access code 35, the customer 7 will be instructed to try again, though after a few (preferably 2 or 3) unsuccessful attempts, the phone dialog will be aborted. Access code 35 will prevent the possibility of usurping the control of camera 31 by a remotely positioned “hacker”.

In one particular embodiment, when the image-taking session is established, customer 7 is given the option to set up a password to be used later for retrieving the images taken during the image-taking session.

Once the image-taken session is established, the control means 32 begins the constant transmission of the image as camera 31 sees it to a display of the mobile computing device 8. Moreover, control means 32 transfers the control functions of the camera 31 to the mobile computing device 8. In particular, control means 32 generates a table of functions that corresponds to various buttons of communication device 8. By pressing the buttons, the customer 7 can operate the camera (e.g. tilt right, zoom in, shoot). The display of communication device 8 guides the customer by providing a preview of the image.

When the image is taken, a media file is generated by control means 32. The media file includes the captured image and the identifier, identified by the “caller ID”, corresponding to the mobile computing device 8.

The media file is then transferred by the control means 32 to the remote server 4 via communication system 3. Server 4 indexes the media file according to the associated identifier and accordingly stored in a database of server 4. If, for example, customer 7, uses the same mobile computing device a different image taking systems at different locations, the images taken by all of these image taking systems are stored in the database and associated with the same cellular phone number.

In one embodiment, the image taking session is terminated by the customer 7, by, for example, hanging up. In another embodiment, the image-taking system 1 reaches a maximum predetermined number (e.g. 10) of images. In yet another embodiment, the session is terminated when a predetermined allotted time (e.g. 5 minutes) is reached.

When customer 7 wants to retrieve any of the images captured by the camera 31, the customer can use a photo terminal found at places of interest, for example, at the exits of museums, parks, etc., which can be used to place the order for prints or files on particular storage media, where the payment and fulfillment of the order can be performed by the terminal in real time.

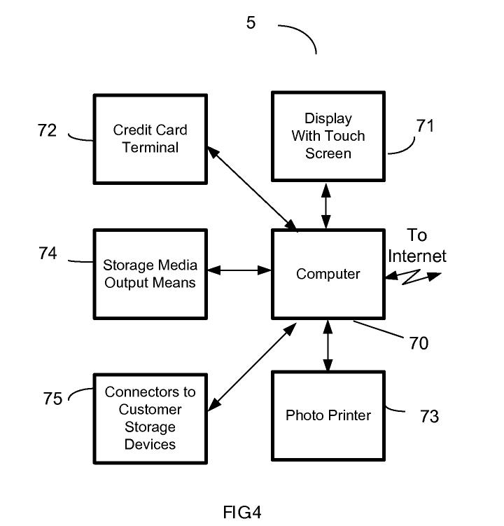

With reference to FIG. 4, an exemplary photo output terminal is illustrated. Photo output terminal 5 includes a computer 70 connected to communication system 3 and having special ordering, photo editing, and photo output software installed (not shown). Computer 70 includes a display 71 having input means such as a touch screen, and a credit card terminal 72 which accepts credit cards payments. A printer 73 is in communication with computer 70 for printing photo generated by the image-taking system. Storage media output means 74, e.g. a digital storage disc writer, are also connected to the computer 71 and provide the possibility to write the ordered images and video and audio files to the digital storage media. The computer 71 also has connectors to customer storage devices 75, which give customer 7 the ability to write the media files ordered to their own storage devices, such as USB sticks, memory cards, etc.

The customer 7 can begin a session with terminal 5 by, for example, touching screen of display 71. Customer 7 will be prompted to enter the identifier corresponding to the mobile computing device 8. If the alphanumeric password for retrieving images was setup during the dialog between the customer and the image taking system, this password should be provided.

The computer 71 creates a request containing all information entered by the customer, and transmits the request via the communication system 3, to the server 4. Upon receipt of the request, the server 4 then searches for all media files associated with the received identifier corresponding to the mobile computing device 8, and returns all the files retrieved to the computer terminal 70 according to the request.

Working with the terminal 5 and using the appropriate software the customer 7 can edit the received photo images creating the final images to be printed, and order the photo prints in required sizes paying for them with her/his credit card using the credit card terminal 72. The photo prints ordered are printed at photo printer 73. The customer can also review the video images and images, which are accompanied by the recorded audio files and order the copies of all these files. These copies can be ordered on video discs using the storage media output means, or the customer can connect her/his own storage devices, such as USB sticks, memory cards, etc., to the connectors to customer storage devices 75 and receive the copies of the files ordered on her/his own device. The payment for all the files is done with the credit card using the credit card terminal 72.

Most often the customers of the image management system 1 will place the order through the internet. The order can be placed for the still images prints, or for the files with still images, or for the files with still images with accompanied audio files, or for video images files, or for video images files with accompanied audio files, where files can be either transferred through the Internet, or send to the ordering customer as the files on a particular storage media, such as audio or video discs, etc. The customer can do it from any Internet-enabled device, such as computer, cellular phone, etc. having an access to the Internet. The order can be placed for the purchase of photo prints, the storage media (such as CD or DVD) with the files containing the particular images taken, or just the transfer of these files to the customer internet-enabled device. To place the order the customer goes on Internet to the image management system website and logs in using as a user name a phone number of the cellular-enabled device 8, which was used during particular image taking session. If the alphanumeric password for retrieving images was setup during the dialog between the customer and the image taking system, this password should be provided.

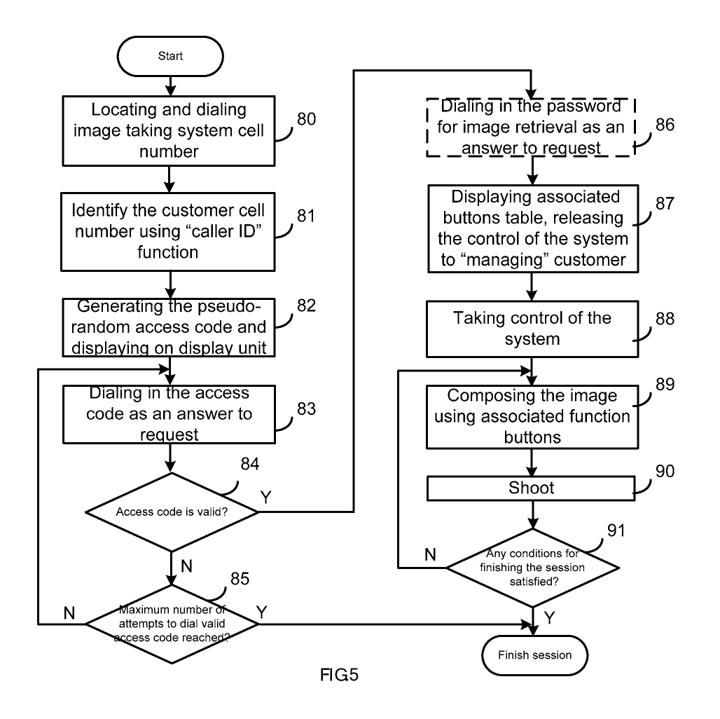

With reference to FIG. 5, a method of operating an image-capturing device using a mobile computing device, in accordance with the present disclosure is described. In one embodiment, an image taking session starts when a customer 7 approaches the visually distinguished marks 30. At step 80, customer 7 locates and dials the cellular number established by the cellular modem 33 using a mobile computing device 8. At step 81, an identifier, such a the customer cell phone number, is identified using a “caller ID” function of the cellular modem 33. After establishing the connection, the image taking system 1 identifies and stores the cellular number of communication device 8. At step 82, the system generates a random access code 35 and displays the code on a display unit 34. At step 83, customer 7 enters this access code when prompted. At step 84, the dialed-in access code is verified by the image taking system against the value 35 displayed on the display unit 34. If the dialed access code is invalid, customer 7 is given the opportunity to dial the correct code 35. If the number of such unsuccessful attempts reaches a predetermined maximum (step 85), then the image taking session is terminated. At step 86, if the dialed in value for the access code 35 is valid, customer 7 is given the option to establish a password for subsequent image retrieval.

At step 87, once the access code 35 is verified, the image taking system 2 transfers the control of camera 33 from control means 32 to mobile computing device 8. A menu of operation is provided which correlate the operating functions of the camera 31 and movable platform 37 to at least one button of the communication device 8. At step 88, customer 7 takes control of the imaging system 2 via the mobile computing device 8. At step 89, customer composes at least one image, and taking the image (step 90) using a “shoot” function.

Throughout the image taking session, the image-taking system 2 is checking for the satisfying at least one of a plurality of conditions that would terminate the session (step 91). If any of such conditions is detected, the image taking system finishes the image taking session.

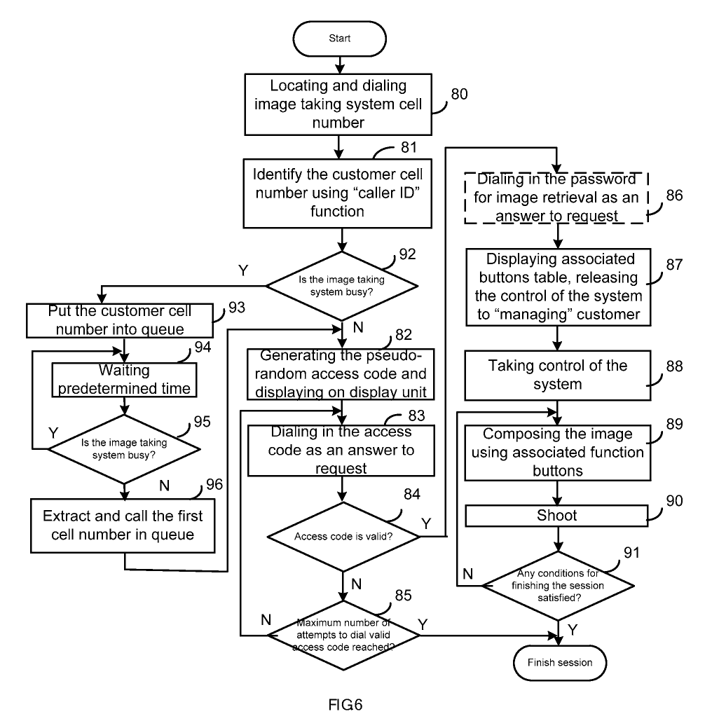

With reference to FIG. 6, another embodiment of the method of operating an image-capturing device using a mobile computing device is described. In this particular embodiment, after step 81 (FIG. 5), in step 92, the system 1 checks if that particular image taking system 2 is busy with another customer. To facilitate this, and in an embodiment of the present disclosure, the camera control means 32 includes the ability of call waiting and switching between at least two phone calls. The same function can be realized using special software in the communication system. So it should be understood that the following sequence of actions, which defines the method proposed, can be performed either by the camera control means through the cellular modem 33, or by the special software by a cellular provider.

Thus, at step 93, if an image-taking system 2 is busy, the customer cell number is put in the queue. After some waiting time (step 94) a second check to determined if the image taking system 2 is busy with another customer is performed (step 95). If the image taking system 2 is still busy, the process returns and waits again. At step 96, if the image taking system 2 is not busy, then the system will extract the first cell number from the head of the queue and called back by the camera control means. Upon establishing the connection the process continues exactly the same, as in the embodiment described in FIG. 5.

While FIGS. 1-6 illustratively describe exemplary components and devices that can be used to practice the exemplary systems and methods, according to specific embodiments of the present invention, it is clear that a person ordinarily skilled in the art can readily modify the demonstrated devices as well as the method steps for adaptation to application requirements consistent with the above descriptions. It should therefore be recognized that the present invention is not limited to the specific embodiments illustrated hereinabove, but rather extends in utility to many other modification, variation, application, and embodiment, and accordingly, all such modifications, variations, applications, and embodiments are to be regarded as being within the scope of the invention.

What is claimed is:

1. An image management system comprising:
a mobile computing device that is a cellular-enabled wireless device; and
an image taking system in communication with a server, the image taking system comprising:
an image capturing device oriented towards distinguishing mark, the image capturing device having a plurality of control functions; and
a control unit in communication with the mobile computing device such that the control unit transfers at least one of the plurality of control functions to the mobile computing device for controlling operation of the image capturing device;
wherein the mobile computing device establishes communication with the control unit by dialing a predetermined phone number of the control unit and operates the image capturing device to capture at least one image.

2. The image management system of claim 1, wherein the control unit transmits the at least one image to the server.

3. The image management system of claim 1, wherein the server uses an identifier corresponding to the mobile computing device to index and store the at least one image.

4. The image management system of claim 1, wherein the user of the mobile computing device receives a temporary password generated by the control unit prior to controlling operation of the image capturing device.

5. The image management system of claim 1, wherein the at least one image is associated with an identifier corresponding to the mobile computing device.

6. The image management system of claim 5, wherein the identifier corresponding to the mobile computing device is one of a mobile communication number and a serial number.

7. The image management system of claim 5, wherein the control unit generates a media file, the media file containing the at least one image and the identifier corresponding to the mobile computing device.

8. The image management system of claim 7, wherein the control unit transfers the media file to the server.

9. The image management system of claim 8, wherein the server indexes the media file according to the identifier corresponding to the mobile computing device.

10. The image management system of claim 9, further comprising a media output terminal that retrieves the media file in response to receiving an identifier corresponding to the mobile computing device.

11. The image management system of claim 1, further comprising a media output terminal that receives the identifier corresponding to the mobile computing device, wherein the media output terminal retrieves the at least one image.

12. The image management system of claim 1, wherein the distinguishing marks is at a predetermined location for establishing a preferred position of a subject.

13. The image management system of claim 1, wherein the control unit transmits an image from the image-capturing device to a display of the mobile computing device.

14. The image management system of claim 1, wherein the control functions includes at least one of zoom, pan, tilt, image capture, time-elapse image capture, and a combination thereof.

15. The image management system of claim 1, wherein the image-capturing device is one of a digital camera and a video camera.

16. The image management system of claim 1, wherein image is one of a still image and a video image.

17. The image management system of claim 1, wherein the mobile computing device creates an audio file, wherein the audio file is associated with the at least one image.

18. The image management system of claim 1, wherein the control unit generates a media file, the media file including the at least one image, an audio file and an identifier corresponding to the mobile computing device.

19. The image management system of claim 3, wherein the server receives the identifier corresponding to the mobile computing device from a customer, retrieves media files corresponding to the identifier, and responds to a customer request via one of transferring the media files to an Internet-enabled device associated with the customer and generating an order to print images from media files and deliver the images to the customer.

20. A media management system comprising:
a mobile computing device; and
an image capturing system in communication with the mobile computing device, the image capturing system comprising:
an image capturing device oriented towards a visually distinguishing mark; and
a communication control unit that establishes an image capturing session in response to an initiation by the mobile computing device, the communication control unit detecting an identifier associated with the mobile computing device,
wherein the communication control unit transmits to the mobile computing device a menu of control functions to control operation of the image capturing device to capture at least one image; and
wherein the image capturing system creates a media file by associating the identifier of the mobile computing device with the least one image, and further wherein the image capturing system transmits the media file to a server.

21. The media management system of claim 20, wherein the communication control unit receives instructions from the mobile computing device to control operation of the image capturing device.

22. The media management system of claim 20, wherein the mobile computing device is at least one a PDA, a cell phone, a laptop, an i-phone, and a cellular-enabled wireless device.

23. The image management system of claim 20, wherein the image-capturing device is at least one of a still camera and a video camera.

24. The image management system of claim 20, wherein the control function includes one of zoom, pan, tilt, media capture, and time-elapse media capture.

25. The image management system of claim 20, further comprising an output terminal that receives, from a customer, an authentication token associated with the mobile computing device, associates the authentication token with the identifier, retrieves media file corresponding to the identifier and transfers media from the media file to at least one of a printer, a storage device and a computing device.

26. The image management system of claim 20, wherein the server receives the identifier corresponding to the mobile computing device from a customer, retrieves media files corresponding to the identifier, and responds to a customer request via one of transferring the media files to an Internet-enabled device associated with the customer and generating an order to print images from media files and deliver the images to the customer.

27. A method of operating an image-capturing device using a mobile computing device, the method comprising:
establishing, by a mobile computing device, an image capturing session with an image capturing system, the image capturing system having a control unit;
transmitting, by the control unit, to the mobile computing device control functions for controlling operation of an image capturing device;
capturing, by the image capturing device, at least one image in response to operation by the mobile computing device; and
creating, by the image capturing system, a media file, the media file having the at least one image and an identifier associated with the mobile computing device.

28. The method of operating an image-capturing device of claim 27, further comprising streaming, by the control unit, the at least one image to the mobile computing device, prior to capturing the at least one image.

29. The method of operating an image-capturing device of claim 27, further comprising transmitting, by the image capturing system, the media file to a server.

30. The method of operating an image-capturing device of claim 29, further comprising retrieving, by an output terminal, the media file from the server, in response to an initiation session.

31. The method of operating an image-capturing device of claim 30, wherein the initiation session includes receiving, by the output terminal, the identifier associated with the mobile computing device.

32. The method of operating an image-capturing device of claim 27, wherein the control functions include one of zoom, pan, tilt, media capture, and time-elapse media capture.

33. The method of operating an image-capturing device of claim 27, further comprising receiving, by the control unit, an audio file created by the mobile computing device, wherein the control unit associates the audio file with the at least one captured image.

34. The method of operating an image-capturing device of claim 27, further comprising receiving, by the mobile computing device, a password generated by the control unit, wherein the password is associated with the identifier corresponding to the mobile computing device prior to controlling operation of the image capturing device.

35. The method of operating an image-capturing device of claim 27, further comprising establishing, by the control unit, an authentication token for retrieving the media file.

36. The method of operating an image-capturing device of claim 27, further comprising establishing, by the mobile computing device, an authentication token for retrieving the media file.

37. The method of operating an image-capturing device of claim 27, wherein the image capturing device is one of a digital camera and a video camera.

38. The method of operating an image-capturing device of claim 27, wherein the image capturing device is oriented towards a plurality of distinguishing marks.
